(19) United States
(12) Patent Application Publication
(10) Pub. No.: US 2004/0249743 A1
(43) Pub. Date: Dec. 9, 2004

(54) Redistribution of resources

(75) Inventors: Botand Istvan Virginas, Ipswich (GB); Gilbert Kwame Owusu, Ipswich (GB); Christos Voudouris, Ipswich (GB); George Anim-Ansah, Ipswich (GB); Lyndon Chi-Hang Lee, Ipswich (GB)

Correspondence Address: NIXON & VANDERHYE, PC, 1100 N GLEBE ROAD, 8TH FLOOR, ARLINGTON, VA, 22201-4714, US

(73) Assignee: BRITISH TELECOMMUNICATIONS public limited company

(21) Appl. No.: 10/853,710

(22) Filed: May 26, 2004

(30) Foreign Application Priority Data
Jun. 5, 2003 (GB) 0312942.6

(51) Int. Cl. G06F 17/60

(52) U.S. Cl. 705/37

(57) ABSTRACT

The invention provides methods and systems for assisting in the redistribution of resources between entities each having sets of tasks which must be performed, pools of resources for performing tasks, and a manager capable of reviewing the tasks and the resources of the entity and determining therefrom surplus resources not required for the performance of the tasks of that entity, and sought-after resources required for the performance of tasks not able to be met by the resources of that entity. The method comprises: receiving offers of surplus resources and requests of sought-after resources from each entity; subjecting received offers and requests to an optimisation procedure to determine a set of matched pairs, each pair comprising an offer received from an entity and a request received from another entity, said offer and request having corresponding characteristics; and communicating information relating to matched pairs to the respective entities.

### TECHNICAL FIELD

The present invention relates to methods and systems for facilitating the redistribution of resources, such as equipment or human resources for example, between different entities.

### BACKGROUND TO THE PRESENT INVENTION AND PRIOR ART

Workforce resource planning is traditionally a manual task. Optimisation methods have been applied to the problem, but they are designed for resource redistribution problems within the same organisational unit. A few products have claimed to provide comprehensive resource redistribution solutions.

“ClickPlan” by Click software (see http://www.clicksoftware.com/main.asn?csid=19) is claimed to be an optimised workforce planning solution for determining the best deployment strategy to maximise the coverage of a workload, and minimise the cost to do so—weeks, months, or years in advance. However, it only deals with intra-organisational optimisation and provides semi-optimisation only.

U.S. Pat. No. 5,911,134 (Castonguay et al) discloses a method for planning, scheduling and managing personnel in an environment such as a telephone call centre in which there is a varying workload, staffed by a team having a variable number of servers. The method involves organising the team into a plurality of management units each having one or more individual servers, and allocating the expected event load between the management units in accordance with the number of servers expected to be available to each unit during the relevant time period. While taking account of the characteristics of the different management units, the method only aims to assist the separate management units in the pursuit of a common goal.

U.S. Pat. No. 6,415,259 (Wolfinger et al) discloses a system of work progress tracking and management which aims to optimise work schedules taking into account factors such as workforce utilisation, customer priority and geographical constraints, but the overall optimisation is with respect to the schedule of one organisation.

Further systems that perform scheduling and optimisation with respect to groups within one organisation or with a common goal are disclosed in U.S. Pat. No. 5,963,911 (Walker et al), U.S. Pat. No. 6,334,133 (Thompson et al), U.S. Pat. No. 5,913,201 (Kocur), U.S. Pat. No. 7,765,140 (Knudson et al) and WO98/22897 (Lesaint et al). In such systems, any decision-making process as to whether resources are redistributed is performed centrally, by an overseeing “manager” for example.

Technical Problems

The systems referred to above are not designed to facilitate redistribution of resources between entities which are autonomous, or even semi-autonomous, with regard to any decision-making on matters of resource redistribution. With reference to the field of telecommunications, for example, a national telecommunications services organisation may consist of a number of entities such as local or regional Customer Service Teams (CSTs) which are managed individually, and may be in competition with each other, at least to a limited extent. Each entity may be under the control of a manager who may use a “Dynamic Planner” system such as that disclosed in WO98/22897 to allocate or internally redistribute the resources of that entity amongst the tasks of that entity in an efficient manner. It will be noted that if an overseeing manager either of the national organisation or of a region of the national organisation were to use such a system and to order local or regional entities to exchange resources in order to increase efficiency, the local or regional entities would not be acting autonomously with regard to the decision-making on matters of resource redistribution.

Embodiments of the present invention aim to provide a platform for the redistribution of resources between entities which may be semi- or fully autonomous, and which may therefore be suitable for both intra-organisational and inter-organisational resource management. The starting point for such embodiments may be the wish for entities to be able to offer their own under-utilised resources to other entities in order to carry out tasks which other entities are unable to carry out using their own resources, and their corresponding wish to be able to take on the under-utilised resources of other entities in order to carry out tasks which they are unable to carry out using their own resources. Such exchanges of resources may be carried out in return for financial profit, or for other types of gain, or may be carried out according to other sets of rules, or even in isolation, but it will be noted that with regard to any final or managerial decision-making on matters of resource redistribution, such embodiments allow the entities to act autonomously or semi-autonomously. On account of this lack of central control, it has been recognised that there may be competing requirements from the managers of the respective entities, leading to situations in which there is no single “best” solution. It has also been recognised that there may be a need for the use of multi-objective optimisation in order to balance such competing requirements, of a type which cannot generally be achieved “manually”, by a human manager for example.

### SUMMARY OF THE INVENTION

According to a first aspect of the present invention, there is provided a system for assisting in the redistribution of resources between a plurality of entities, each entity having:

a set of tasks requiring to be performed;

a pool of resources capable of performing certain tasks, each resource being characterised by resource characteristics; and

a manager, capable of reviewing the set of tasks and the pool of resources of the entity and determining therefrom surplus resources not required for the performance of the tasks of that entity, and sought-after resources required for the performance of surplus tasks not able to be met by the resources of that entity;

the system comprising:

input means for receiving, in respect of each of a plurality of entities, offers comprising characteristics of surplus resources of the entity, and requests comprising characteristics of sought-after resources of the entity;

optimisation means for subjecting received offers and received requests to an optimisation procedure whereby to determine a set of matched pairs, each pair comprising an offer received from an entity and a request received from another entity, said offer and said request having corresponding characteristics; and

output means for communicating information relating to matched pairs to the respective entities.

According to a second aspect of the present invention, there is provided a method of assisting in the redistribution of resources between a plurality of entities, each entity having:

a set of tasks requiring to be performed;

a pool of resources capable of performing certain tasks, each resource being characterised by resource characteristics; and

a manager, capable of reviewing the set of tasks and the pool of resources of the entity and determining therefrom surplus resources not required for the performance of the tasks of that entity, and sought-after resources required for the performance of surplus tasks not able to be met by the resources of that entity;

the method comprising:

receiving, in respect of each of a plurality of entities, offers comprising characteristics of surplus resources of the entity, and requests comprising characteristics of sought-after resources of the entity;

subjecting received offers and received requests to an optimisation procedure whereby to determine a set of matched pairs, each pair comprising an offer received from an entity and a request received from another entity, said offer and request having corresponding characteristics; and

communicating information relating to matched pairs to the respective entities.

According to a third aspect, the present invention further provides a computer program or suite of computer programs arranged such that when executed by a computer system it/they cause the computer system to operate according to the above method.

Moreover, according to a fourth aspect, the invention also provides a computer readable storage medium arranged to store a computer program or suite of computer programs according to the third aspect of the invention. The computer readable storage medium may be any magnetic, optical, magneto-optical, solid-state, or other storage medium capable of being read by a computer.

Embodiments of the above invention allow for the provision of a comprehensive resource management system for assisting entities in

(i) alleviating resource shortages and

(ii) trading surplus resources, for profit or otherwise.

Entities may thus be assisted in (a) meeting customer commitments, (b) improving quality of service and (c) reducing operation costs. This assistance may thus be of value to resource managers who wish to (i) acquire additional resources in order to reduce work demand volumes or (ii) lend (possibly for profit) under-utilised resources over the Internet, within a corporate Intranet, or otherwise. The system may comprise an Application Program Interface (API), and may be used in combination with other applications to manage resource trading from need identification to trading utilisation.

Embodiments of the system may be incorporated in a multi-stage system offering comprehensive support during all stages of planning, resource distribution and trading, which may allow for incorporation of tactical and strategic activities over various time-scales of resource management.

According to preferred embodiments of the invention, the optimisation means may subject received offers and received requests to a multi-objective optimisation procedure, whereby allowing the system to take account of a plurality of types of resource characteristics, when assisting in the redistribution of resources between entities. Examples of multi-objective optimisation procedures include procedures using Multi-Objective Genetic Algorithms such as Pareto Optimisation, which allow optimisation to take account of soft and hard constraints. A good account of this is provided in the article “Metamodel Representations for Robustness Assessment in Multiobjective Optimization” by Andersson J. and Krus P., Proceedings of the International Conference on Engineering Design ICED 01, Glasgow, UK, Aug. 21-23, 2001 (available online at: http://www.machine.ikp.liu.se/staff/iohan/files/paperC586-425.pdf)

The problem of resource redistribution may thus be formulated and solved as a multi-objective optimisation problem. Recognising that the task of multi-objective optimisation is different from that of single-objective optimisation in that in multi-objective optimisation, there is usually no single solution which is optimum with respect to all objectives, systems according to preferred embodiments of the invention aim to determine a set of optimal solutions, such as Pareto-optimal solutions, non-inferior solutions, or effective solutions.

Assuming that more than one optimal solution is found and that without further information no one solution can be said to be better than any other optimal solution, one of the goals of multi-objective optimisation may be to find as many optimal solutions as possible, each of which may be thought of as optimised when viewed from the standpoint of a particular objective. According to preferred embodiments, the system determines an optimal subset of possible solutions by first taking into account hard constraints (e.g. maximum acceptable travelling distance for the transfer of the resource from the “offering” entity to the “requesting” entity, minimum skills or qualifications required for the offered resource to match the requirements of the requesting entity, maximum price that the requesting entity is willing to pay for the requested resource, minimum price that the offering entity is willing to accept for the offered resource, etc.), then selects from these the best response taking into consideration soft constraints (i.e. user preferences) such as whether a manager would prefer to acquire an engineer with the shortest travelling distance or an engineer who is the most proficient in the required skill in selecting the one that is the best match from the subset.

Different configurations may be used, depending on factors such as the relationship between the entities, and the corporate environment. Systems according to embodiments of the invention may be configured according to Centralised or Decentralised models, Fully-Collaborative, Semi-Collaborative, or Fully-Competitive models, Currency-Based, Non-Currency-Based, Single-Objective or Multi-Objective-Based models, or other models.

Embodiments of the invention will now be described with reference to the accompanying figures, in which:

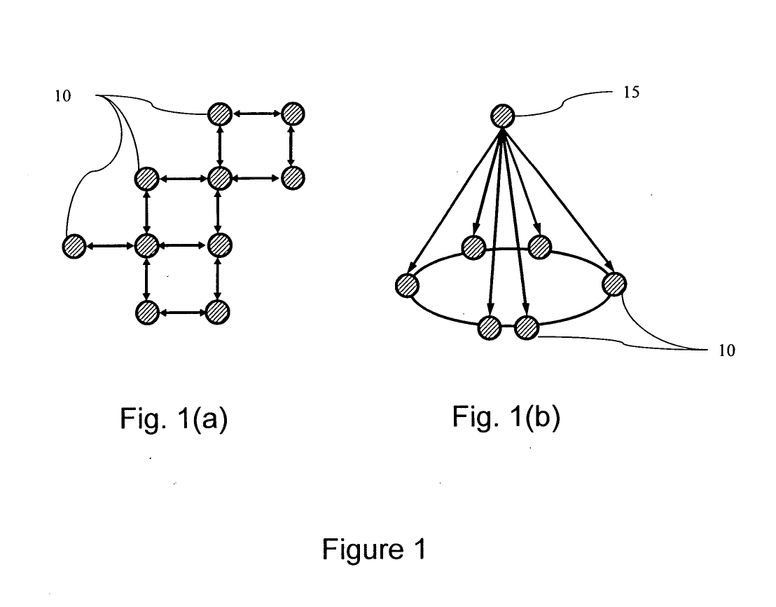

FIG. 1 illustrates two types of relationships which may exist between entities;

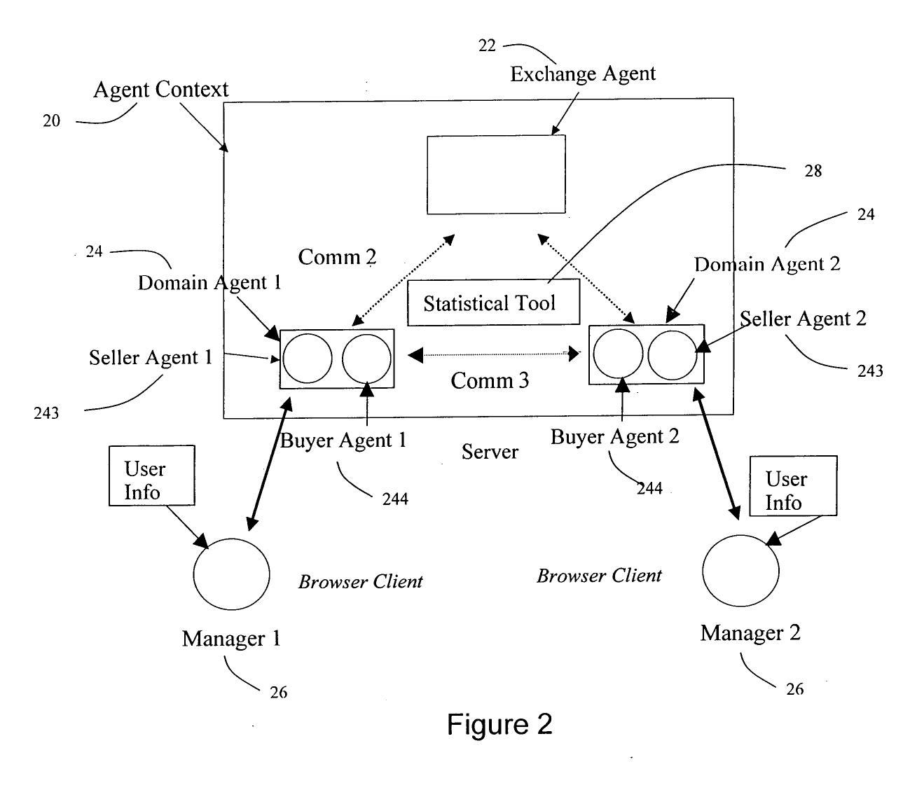

FIG. 2 illustrates the system architecture of a resource redistribution system according to an embodiment of the present invention;

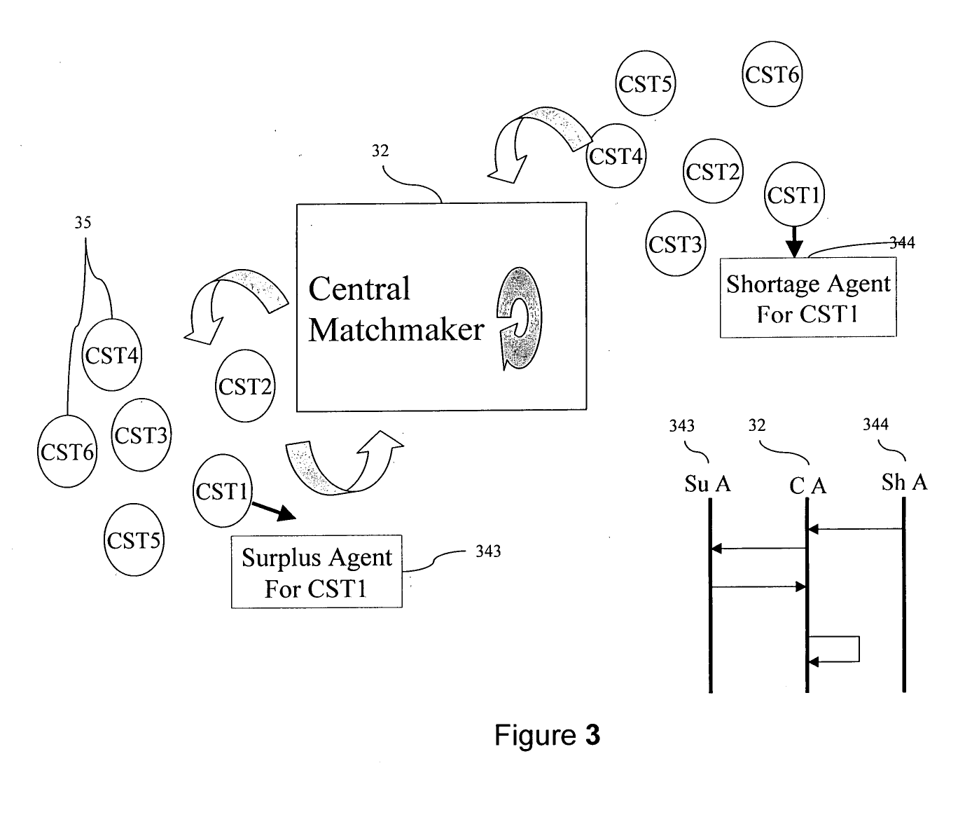

FIG. 3 illustrates resource redistribution between entities wherein a redistribution system according to an embodiment of the present invention acts as a Central Matchmaker;

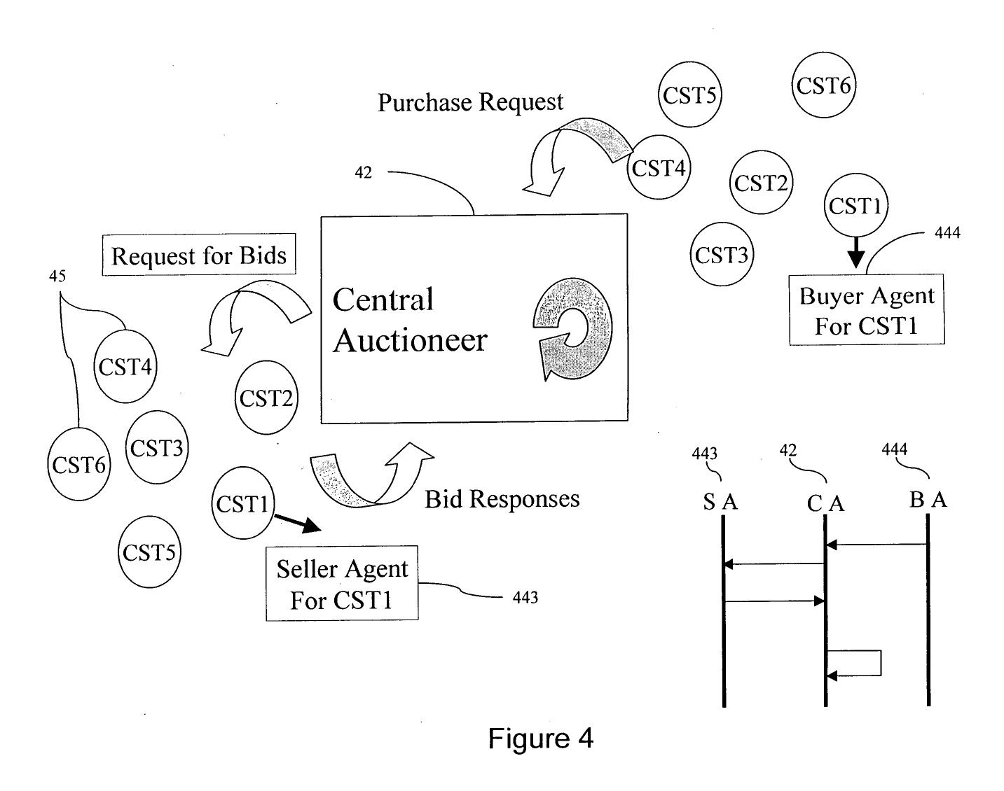

FIG. 4 illustrates resource redistribution between entities wherein a redistribution system according to an embodiment of the present invention acts as a Central Auctioneer;

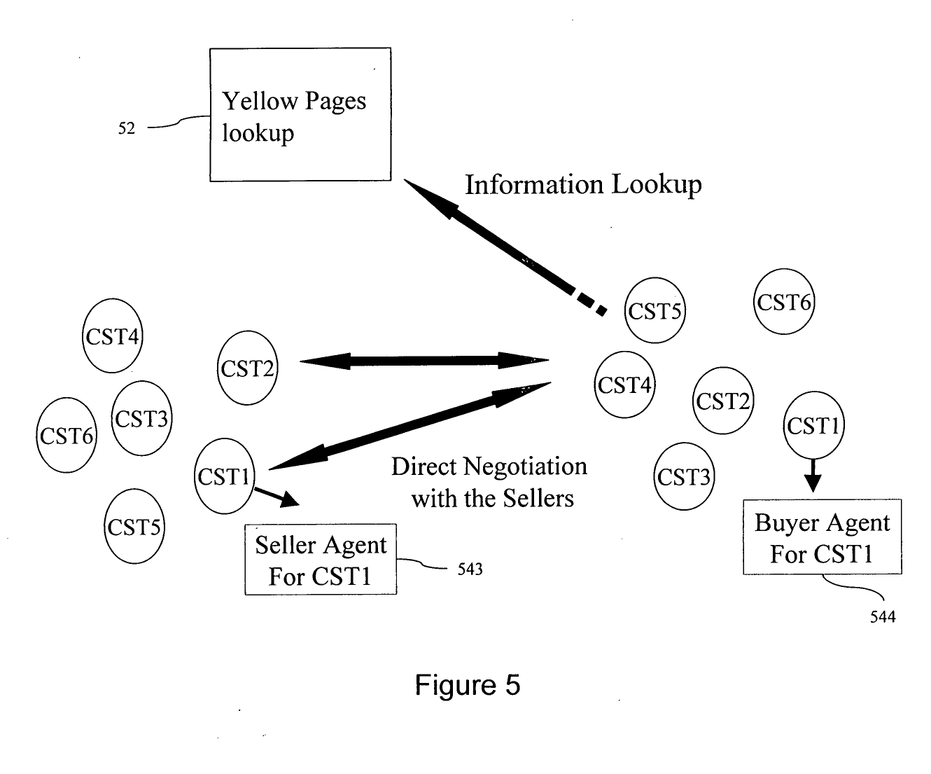

FIG. 5 illustrates a fully distributed (or “de-centralised”) redistribution environment.

### DETAILED DESCRIPTION

With reference to FIG. 1, two types of relationships which may exist between entities are illustrated. As shown in this “Tier and Peer” architecture, FIG. 1(a) indicates purely horizontal interaction between a number of entities 10 which may be semi-autonomous or fully-autonomous business units such as Customer Service Teams (CST), each having a semi-autonomous or fully-autonomous resource manager, each entity 10 being responsible for a particular geographical and/or business region. FIG. 1(b) indicates an environment in which there is a degree of vertical control or management, whereby an overseeing resource manager 15 is able to impose some constraints on the behaviour of the semi-autonomous resource managers of entities 10 on the same horizontal hierarchical level.

The role of resource manager for an entity 10 may be taken by a human with or without the assistance of a local computer-implemented resource planning system. Alternatively, the role of entity resource manager may be taken by an intelligent resource planning system capable of performing some of the functions of a human resource manager and interacting with a resource redistribution system according to the present invention, in accordance with criteria provided by, or the wishes of, a human manager, for example.

The horizontal level in the redistribution environment may thus comprise a number of semi-autonomous or fully-autonomous resource managers (as in FIG. 1), each responsible for a geographic and/or a business region. Prior to any interaction with a resource redistribution system according to an embodiment of the present invention, the resource manager of an entity reviews the current or predicted set of tasks of that entity and the pool of resources of the entity, and determines therefrom whether that entity currently has any surplus resources not required for the performance of the current or predicted tasks of that entity, and whether that entity currently requires any “sought-after resources”, i.e. resources which would be required from elsewhere for the performance of surplus tasks which cannot currently be met by the resources of that entity. The local resource managers thus take local decisions based for example on their local calendarised work demand and resource availability profiles. Their behaviour may also be governed by business policies local to the region they represent. In the event that a local resource manager anticipates a heavy work demand, it could negotiate for additional resources from neighbouring local resource managers. Such negotiation is again, to a large extent, governed by the local business policies imposed on the resource manager. Via horizontal interaction, the planners can perform load balancing whilst still attempting to optimise their local objectives.

In the event that there is an additional vertical level in the management hierarchy, such as in the exemplary case of a national telecommunications services organisation comprising a number of entities (i.e. local or regional individually-managed Customer Service Teams), the vertical level may support a centralised view of the organisation, allowing visualisation of its global behaviour and the imposition of global business policies. It should be noted that even in such a centrally-managed organisation, resource redistribution decisions may still be taken on a local level by entities who may act semi-autonomously or fully-autonomously in relation to matters of resource management. Systems according to embodiments of the invention are thus also of relevance to such organisations.

The resource redistribution problem may be modelled as a multi-agent co-ordination problem. The architecture of a resource redistribution system according to an embodiment of the present invention is set out in FIG. 2.

As shown in FIG. 2, the resource redistribution system and the relevant functional parts of the entities with which it interacts may be represented as a Multi-Agent System as follows:

The resource redistribution system according to an embodiment of the invention, shown here as the Exchange Agent 22, exists in an Agent Context 20 in which it can interact with Domain Agents 24. The Agent Context shown only illustrates the interactions between the Exchange Agent and two Domain Agents, but there would usually be more than two Domain Agents in the Agent Context. Each Domain Agent acts on behalf of a Domain Manager 26, which in turn acts on behalf of an Entity (not shown). The role of the Domain Agent is to act in the interests of, or according to the instructions of, that Entity (indicated by “User Info”) during interactions within the Agent Context. The Domain Managers thus act as principals of the exchange interaction. At any time, they may or may not have resources they wish to exchange. They may interact with the system by means of a lightweight client approach (e.g. using browsers).

The Domain Agents 24 reside in the Agent Context 20, and act according to the desires of their principals. The Domain Agents may possess the intelligence to engage in negotiation and to play the market game, or may simply follow precise instructions. Each Domain Agent 24 may consist of a Seller Agent 243 and a Buyer Agent 244, whereby each Domain Manager 26 has one Seller Agent and one Buyer Agent associated with them in the Agent Context 20.

A Seller Agent 243 is provided by the Domain Manager with information relating to surplus resources, and has a main objective to sell or distribute these. A Buyer Agent 244 is provided by the Domain Manager with information relating to resource shortages, and has a main objective to buy or acquire resources to satisfy these shortages. Alternatively, a Domain Agent 24 may be provided by the Domain Manager with both types of information.

The functionality of the Exchange Agent 22, which will be described in greater detail, may be engineered in different ways based on the selected marketplace model, for which various options are summarised later. According to the system shown in FIG. 2 the Exchange Agent 22 is shown acting as a “Central Matchmaker” (see FIG. 3) and uses a multi-criteria optimisation algorithm such as a Pareto genetic algorithm to determine possible solutions for the redistribution of resources.

The Agent Context 20 is the platform in which the agents reside and operate. It provides the infrastructure for the agents to interact and conduct their activities. An example of a suitable platform is the BEA Weblogic Integration B2B platform. The platform may be provided centrally, at a location remote from the entities, for example, or it may be provided by one or more of the entities, or where facilitated by an intranet for example, it may be distributed amongst the entities.

Resource Redistribution: the Resource Management Process

With reference to FIGS. 2 and 3, the steps involved in performing redistribution of resources using a system according to a preferred embodiment of the invention will be described. In this embodiment, the resource redistribution system, configured as a central matchmaker 32, tries to match offers from “Seller (i.e. Surplus) Agents” 343 with requests from “Buyer (i.e. Shortage) Agents” 344 each agent representing one of a number of CSTs 35, by performing multi-objective optimisation involving multiple objectives such as minimising the travelling distances of technicians (the resources) exchanged between CSTs, matching the skills of technicians offered by one CST as closely as possible with the skills required by another CST in order to perform the surplus tasks of another CST, concentrating on obtaining resources to perform most-critical tasks, maximising overall productivity, and others.

An overseeing manager may inform the domain (i.e. CST) managers 26 of the following trading parameters for the process ahead:

a planning period (for example, one day ahead);

a “start market” time: at which time the exchange agent will start to receive the offers and requests of the CST managers, via their respective domain agents;

a “start trading” time: at which time the exchange agent will attempt to start the matchmaking process; and

an “end trading” time: at which time no further offers or requests will be received.

Once these parameters are set, a three stage process is followed, consisting of a Pre-Trading Stage, a Trading Stage and a Post-Trading Stage.

Before or during the Pre-Trading stage, which starts at the “start market” time, CST managers may use their own internal tools (e.g. a local “Dynamic Planner”, as described above) for local or internal redistribution of resources within their own CST. Each day, or in relation to each planning period, sub-optimal solutions may arise. Therefore CST managers identify resource shortages and surpluses for the period set by the overseeing manager, and compile lists of shortages and surpluses. Shortages may be ranked based on an importance score, the most critical shortage being given the highest score.

Managers instruct their domain agents 24, 343, 344 to submit their respective lists of shortages and surpluses to the Central Matchmaker 32 during the Pre-Trading stage, together with their preferences, which may include criteria such as:

Maximum travelling distance for a transfer

Required skills or proficiency levels, qualifications, or training levels

Whether it is considered more important by the manager to be allocated resources having the shortest travelling distance or the best proficiency in a required skill.

Such criteria may be grouped according to two types: “Hard Constraints” such as the maximum travelling distance for a transfer to be acceptable, and “Soft Constraints” such as which is considered more important by the manager between two potentially conflicting factors. Constraints may be specified individually for each resource request. Alternatively, some constraints may be given which apply to some or all of the requests in respect a particular entity. For example, an entity manager may wish to specify an absolute maximum travelling distance (a hard constraint) in relation to some or all resource requests, while specifying a preference that for all requests a better skill match is more important than a lower travel distance (a soft constraint).

During the Trading Stage, if the submitted shortages are ranked according to importance, the Central Matchmaker may take account of this in order to give priority to more critical shortages. This may be achieved by servicing the requests one by one, with the highest-ranked request being serviced first, or by servicing a high-ranked group first, then successively lower-ranked groups, until an attempt has been made to service even the lowest-ranked group. Alternatively, all requests may be serviced together, with the importance figure being incorporated in the form of a constraint.

The steps involved in servicing “shortage requests” where the criteria are grouped according to hard and soft constraints may be as follows:

1. For each shortage request, the Central Matchmaker considers all offers of surplus resources received from Seller Agents and determines which have characteristics which would match the characteristics specified as hard constraints of the shortage requests (e.g. matching skill, maximum travelling distance, etc.). This may be achieved using an optimisation algorithm such as Pareto optimisation to select a “Pareto front”, comprising optimal sets of possible matches for the shortage requests taking account of the specified hard constraints.

2. From the optimal sets of possible matches, assuming that more than a single solution is found, the Central Matchmaker then takes account of the characteristics specified as soft constraints of the shortage requests to select a set of “best matches” from the optimal sets, in which the matches between surplus resources offered and sought-after resources required are optimised with respect to the soft constraints specified (user “soft” preferences, such as what is considered to be more important, minimising travel requirements or maximising skill proficiencies). This may be achieved by a simple selection procedure based on the general soft constraints of each entity, on behalf of that entity, or may be achieved by a second optimisation procedure such as Pareto optimisation, in order to take account of the soft constraints specified by several entities individually in respect of several resource requests.

The result of this optimisation procedure is a set of matches which are considered at this stage to be provisional deals. Each match or deal is based on a “correspondence” between the characteristics of an offer received from one entity and the characteristics a request received from another entity.

For each match, the managers of the respective Seller Agents and Buyer Agents may be notified with details of the provisional deal. The agents or their respective managers may choose to reject a provisional deal or withdraw offers of resources or shortage requests, resulting in the following possibilities:

If a provisional deal is rejected by the seller, the buyer will be notified and the request may be included in an updated set of requests in order that it may be serviced again by the Matchmaker.

If a provisional deal is rejected by the buyer, the seller will be notified and the offer may be included in an updated set of offers in order that it may be serviced again by the Matchmaker.

If a resource request is withdrawn by the buyer, it will be deleted from the list of requests to be processed by the Matchmaker.

If a resource surplus is withdrawn, it will be deleted from the particular Seller Agent's surpluses list.

If the seller and buyer agents (or their respective managers) choose to accept a provisional deal at this stage, the respective resource request and resource surplus may be deleted from the respective lists of requests and surpluses prior to any further optimisation procedure.

At predetermined intervals, or whenever the Matchmaker receives changes to the sets of offers and requests, the above process of servicing requests may be repeated until the “end trading” time is reached.

The Post-Trading stage starts at the end trading time set, for example, by the overseeing manager. Provisional deals may then become final deals. The system may perform a process of Aggregation of resources, grouping individual deals for transfer (e.g. if 2 engineers with the same skill from the same CST are planned to be transferred for 2 days to the same CST, then a suggestion could be made to send 1 engineer for 4 days instead).

In the post-trading stage the overseeing manager may have the option to commit the final Plan or to revise the Plan (e.g. in case of an emergency, the overseeing manager can press a Panic Button and abort the proposed Plan).

In order to monitor the various stages of trading to aid decision making the overseeing manager may use the “Statistical Tool” described below in the section on Monitoring of Resource Redistribution.

Monitoring of Resource Redistribution

The Agent Context 20 may include a Statistical Tool 28, the function of which is to provide monitoring of features or statistical information about the state of the exchange during various stages of trading. In the exemplary case of a national telecommunications services organisation comprising a number of local individually-managed Customer Service Teams (CST) each having a number of technicians, the Statistical Tool is a tool that monitors the exchange of technicians between CSTs at regional level. The tool is intended to be used by an overseeing “Regional Manager”. The tool does not change or “influence” any of the data it gets, but may provide a means of viewing what is happening overall across several monitored CSTs. The tool can also be regarded as a statistical tool. The Regional Manager can monitor the state of trading in the region during three distinct stages of the trading, which are described in greater detail in the section on the Resource Management Process. These stages are: the Pre-Trading Stage, the Trading Stage and the Post-Trading Stage.

In the Pre-Trading Stage, Regional Managers may select which CST(s) within the region they are interested in monitoring. Once this selection has been made, the Statistical Tool is provided with the number of surplus and required technicians for each of the CST(s) that it is monitoring. This may then be represented visually in different views e.g. graphs, tables and maps. This provides the Regional Manager with details of the surpluses and requirements of each of the CST(s).

In the Trading Stage, the Statistical Tool allows the Regional manager to monitor which technicians may be moving from one CST to another. This view may be represented in the form of a table and a graphical animator.

In the Post-Trading Stage the Statistical Tool provides a means of reviewing all the trading that occurred between CST(s) in detail. In particular it may provide details of:

a) how many technicians are to be moved between the different monitored CST(s);

b) which actual technicians are involved in the moves;

c) how many surplus technicians for all the individual CSTs were deployed in other CSTs;

d) how many required technicians were provided.

Alternative Marketplace Models

Embodiments of the system according may be configured to act in different ways to assist in the redistribution of resources between entities. These configurations can be grouped in various types of models based on a number of criteria. Based on these models the following types of marketplaces can be identified:

1) “Centralised” or “Distributed” marketplaces: (using centralised and de-centralised models)

1.1) Centralised model: In this type of model, the Agent Context consists of A+1 domain agents 24, one representing each entity, and an exchange agent 22. The role of the exchange agent is to collect information from the domain agents, and to perform overall resource distribution.

1.1.1) Resource Exchange using a Central Matchmaker:

In this model an exchange agent acting as a central matchmaker 32 (see FIG. 3) tries to satisfy requests by performing a multi-objective optimisation using hard constraints and soft constraints provided by Surplus Agents 343 and Shortage Agents 344, which take the respective roles of buyer and seller agents on behalf of CSTs 35. The central matchmaker 32 uses a multi-objective optimisation algorithm (e.g. Multi-Objective Genetic Algorithms like Pareto Optimisation) to select an optimal subset of solutions based on hard constraints. User preferences (soft constraints) will then be used to select the best-preferred solution out of this subset.

1.1.2) Central Auctioneer based Market:

In this model an exchange agent acting as a central auctioneer 42 (see FIG. 4) assists in trying to satisfy requests provided by Seller Agents 443 and Buyer Agents 444 on behalf of CSTs 45. The central auctioneer 42 co-ordinates the market. Various auction protocols may be used such as English auction, Dutch auction, or Reverse auction.

1.2) Distributed or Decentralised model: In the decentralised model, the Agent Context 20 consists of A+1 domain agents 24, one representing each entity, and a directory agent 52 (see FIG. 5). Each domain agent consists of a Seller Agent 543 and a Buyer Agent 544. The directory agent 52 provides a single point of contact for the domain agents to be able to interact with each other.

1.2.1) Distributed Agent Based Resource Redistribution Market:

In this model the domain agents will negotiate directly with each other and the directory agent 52 will provide only “Yellow Pages” type of service, whereby the domain agents may be put in contact with each other prior to any resource trading. Instead of submitting their respective lists of shortages and surpluses to a Central Matchmaker, as is the case with Centralised models, domain agents submit their respective lists of shortages and surpluses directly to each other, and one or more of the entities may comprise the means for receiving these offers and requests, the means for subjecting them to the appropriate optimisation procedure to determine matched pairs of offers and requests, and the means for communicating the results of the procedure to the other entities in order to assist with the redistribution of resources. Such a model allows the entities or their respective domain agents to be completely autonomous, and various negotiation protocols can be utilised.

2) Collaborative versus Competitive Systems:

In the collaborative model the overall system will have a common objective to fulfil. For example, a common goal for the system could be to try to optimise the workforce allocation for an entire region, therefore the agents will have this as their main objective, although the system will take into account conflicting objectives of the entities.

In the competitive model the individual agents will have as their main objective the optimisation of their own workforce allocation, therefore they would compete in the marketplace to attempt to achieve this objective.

3) Multi-Objective versus Common-Currency-Based (single objective) Systems:

The multi-objective model may be used if it is impossible to establish a common currency in the marketplace. In this model buyers and sellers use objectives which cannot be directly compared. The currency based (or single objective) model may be used when buyers and sellers in the marketplace are using comparable currencies (e.g. money)

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

Moreover, for the avoidance of doubt, where reference has been given to a prior art document or disclosure whose contents, whether as a whole or in part, are necessary for the understanding of the operation or implementation of any of the embodiments of the present invention by the intended reader, being a person skilled in the art, then said contents should be taken as being incorporated herein by said reference thereto.

1. A system for assisting in the redistribution of resources between a plurality of entities, each entity having:
a set of tasks requiring to be performed;
a pool of resources capable of performing certain tasks, each resource being characterised by resource characteristics; and
a manager, capable of reviewing the set of tasks and the pool of resources of the entity and determining therefrom surplus resources not required for the performance of the tasks of that entity, and sought-after resources required for the performance of surplus tasks not able to be met by the resources of that entity;
the system comprising:
input means for receiving, in respect of each of a plurality of entities, offers comprising characteristics of surplus resources of the entity, and requests comprising characteristics of sought-after resources of the entity;
optimisation means for subjecting received offers and received requests to an optimisation procedure whereby to determine a set of matched pairs, each pair comprising an offer received from an entity and a request received from another entity, said offer and said request having corresponding characteristics; and
output means for communicating information relating to matched pairs to the respective entities.

2. A resource redistribution system according to claim 1, wherein the optimisation means comprises means for subjecting received offers and received requests to a multi-objective optimisation procedure.

3. A resource redistribution system according to claim 1, wherein the optimisation means comprises means for subjecting received offers and received requests to a Pareto-genetic optimisation procedure.

4. A resource redistribution system according to claim 1 wherein the input means comprises means for receiving characteristics of sought-after resources in the form of hard constraints and soft constraints.

5. A resource redistribution system according to claim 4, wherein the optimisation means comprises:
means for subjecting received offers and received requests to a first stage optimisation procedure whereby to determine one or more sets of matched pairs wherein the characteristics of the offer in each pair correspond with the hard constraints of the request; and
means for subjecting said sets of matched pairs to a second stage selection procedure whereby to determine a set of matched pairs wherein the correspondences between the characteristics of the offer and the soft constraints of the request in each pair are optimised.

6. A resource redistribution system according to claim 1, the system further comprising:
means for receiving messages of withdrawals of offers and requests from the entities;
means for updating the received offers and requests in response to received withdrawal messages; and
means for providing the updated offers and requests to the optimisation means, whereby said optimisation means may subject said updated offers and requests to a further optimisation procedure.

7. A resource redistribution system according to claim 1, the system further comprising:
means for receiving acceptance or refusal messages from the entities in response to said information relating to matched pairs;
means for updating the received offers and requests in response to received acceptance or refusal messages; and
means for providing the updated offers and requests to the optimisation means, whereby said optimisation means may subject said updated offers and requests to a further optimisation procedure.

8. A method of assisting in the redistribution of resources between a plurality of entities, each entity having:
a set of tasks requiring to be performed;
a pool of resources capable of performing certain tasks, each resource being characterised by resource characteristics; and
a manager, capable of reviewing the set of tasks and the pool of resources of the entity and determining therefrom surplus resources not required for the performance of the tasks of that entity, and sought-after resources required for the performance of surplus tasks not able to be met by the resources of that entity;
the method comprising:
receiving, in respect of each of a plurality of entities, offers comprising characteristics of surplus resources of the entity, and requests comprising characteristics of sought-after resources of the entity;
subjecting received offers and received requests to an optimisation procedure whereby to determine a set of matched pairs, each pair comprising an offer received from an entity and a request received from another entity, said offer and request having corresponding characteristics; and
communicating information relating to matched pairs to the respective entities.

9. A resource redistribution method according to claim 8, wherein the optimisation procedure comprises a multi-objective optimisation procedure.

10. A resource redistribution method according to claim 8, wherein the optimisation procedure comprises a Pareto-genetic optimisation procedure.

11. A resource redistribution method according to claim 8 wherein the receiving step comprises receiving characteristics of sought-after resources in the form of hard constraints and soft constraints.

12. A resource redistribution method according to claim 11, wherein the optimisation procedure comprises:
subjecting received offers and received requests to a first stage optimisation procedure whereby to determine one or more sets of matched pairs wherein the characteristics of the offer in each pair correspond with the hard constraints of the request; and
subjecting said sets of matched pairs to a second stage selection procedure whereby to determine a set of matched pairs wherein the correspondences between the characteristics of the offer and the soft constraints of the request in each pair are optimised.

13. A resource redistribution method according to claim 8, further comprising the steps of:
receiving messages of withdrawals of offers and requests from the entities;
updating the received offers and requests in response to received withdrawal messages;
providing a set of updated offers and requests to the optimisation means; and
subjecting said updated set offers and requests to a further optimisation procedure.

14. A resource redistribution method according to claim 8, further comprising the steps of:
receiving acceptance or refusal messages from the entities in response to said information relating to matched pairs;
updating the received offers and requests in response to received acceptance or refusal messages;
providing a set of updated offers and requests to the optimisation means, and
subjecting said updated set offers and requests to a further optimisation procedure.

15. A computer program or suite of computer programs arranged such that when executed by a computer system it/they enable the computer system to operate according to the method of any of claim 8.

16. A computer readable storage medium storing the computer program or one or more of the suite of computer programs according to claim 15.
